(19) United States
(12) Patent Application Publication
(10) Pub. No.: US 2021/0101101 A1
(43) Pub. Date: Apr. 8, 2021

(54) METHOD FOR REDUCING CORROSION IN MACHINERY

(71) Applicant: Purafil, Inc., Doraville, GA (US)

(72) Inventor: William G. England, Doraville, GA (US)

(21) Appl. No.: 15/733,730

(22) PCT Filed: Apr. 25, 2019
(86) PCT No.: PCT/US2019/029072

§ 371 Date: Oct. 7, 2020

Related U.S. Application Data
(60) Provisional application No. 62/662,488, filed on Apr. 25, 2018.

(51) Int. Cl. B01D 39/16; B01D 53/04; B01D 53/22

(52) U.S. Cl. CPC B01D 39/1692; B01D 2257/2025; B01D 53/229; B01D 53/0407

(57) ABSTRACT

Described herein is a method for reducing corrosion of corrodible metals in machinery. More particularly, described herein is a method for removing corrosive gases and particulates from an air flow. A method of removing corrosive contaminants from a fluid stream employing a filter having a multi-layer filtration media is described herein. Also described herein is a method of increasing the operational lifetime of machinery by reducing corrosion in the machine.

### TECHNICAL FIELD

The present disclosure relates generally to methods for reducing corrosion in machinery and more specifically to the use of a filtration media for removing one or more contaminants from a fluid stream such as an air flow into machinery.

### BACKGROUND

Filters for airborne particulate contaminants are widely employed to prevent the particulates from entering an interior of a machine, thereby protecting the inner machinery of the machine. These filters are usually located within an air intake port of the machine. However, some contaminants, such as corrosive gases, are able to pass through or otherwise bypass the filter, enter the interior of the machine and damage the inner machinery of the machine.

Therefore, what is needed is a method of adsorbing and/or absorbing corrosive gases that are able to pass through or otherwise bypass currently available filters as or before they enter the machine, thereby reducing corrosion of the interior of the machine.

### SUMMARY

Disclosed herein is a method for reducing corrosion in machinery, including contacting a filtration media with a fluid stream, wherein the filtration media is positioned between the internal machinery within the machine and the fluid stream entering the machine, and wherein the filtration media adsorbs or absorbs corrosive contaminants in the fluid stream to reduce corrosion of internal machinery within the machine. The filtration media can be positioned in a fluid stream intake port of the machine. The internal machinery within the machine can be made of a corrodible metal (e.g., copper, zinc, steel, aluminum, stainless steel, or any combination thereof). The corrosive contaminant can be a halogen gas (e.g., chlorine, fluorine, bromine, or any combination thereof). In some non-limiting examples, the filtration media can be a polymer (e.g., a water-impermeable polymer, such as expanded polytetrafluoroethylene). In some cases, the filtration media can be a pleated, expanded polytetrafluoroethylene.

In some non-limiting examples, removing at least about 25% of the corrosives from the fluid stream can increase a lifetime of the machine by at least about one year. In some examples, removing at least about 50% of the corrosives from the fluid stream can increase a lifetime of the machine by at least about two years. In some further examples, removing at least about 75% of the corrosives from the fluid stream can increase a lifetime of the machine by at least about four years.

The term “embodiment” and similar terms are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this disclosure, any or all drawings and each claim.

### BRIEF DESCRIPTION OF THE DRAWINGS

The specification makes reference to the following appended figures, in which use of like reference numerals in different figures is intended to illustrate like or analogous components.

FIG. 1A is a digital image of a corroded copper panel according to certain aspects of the present disclosure.

FIG. 1B is a digital image of a protected copper panel according to certain aspects of the present disclosure.

FIG. 2A is a digital image of a corroded zinc panel according to certain aspects of the present disclosure.

FIG. 2B is a digital image of a protected zinc panel according to certain aspects of the present disclosure.

FIG. 3A is a digital image of a corroded steel panel according to certain aspects of the present disclosure.

FIG. 3B is a digital image of a protected steel panel according to certain aspects of the present disclosure.

FIG. 4A is a digital image of a corroded aluminum panel according to certain aspects of the present disclosure.

FIG. 4B is a digital image of a protected aluminum panel according to certain aspects of the present disclosure.

FIG. 5A is a digital image of a corroded stainless steel panel according to certain aspects of the present disclosure.

FIG. 5B is a digital image of a protected stainless steel panel according to certain aspects of the present disclosure.

### DETAILED DESCRIPTION

Certain aspects and features of the present disclosure relate to methods of reducing corrosion within a machine by contacting a fluid stream (e.g., an air flow) entering the machine with a filtration media to remove one or more corrosive contaminants from the fluid stream. The filtration media is used to remove or reduce undesirable contaminants, capable of causing corrosion of metals, from the fluid stream before the fluid stream contacts the internal corrodible metal machinery of the machine.

The filtration media is a water-impermeable/gas permeable polymer such as expanded polytetrafluoroethylene (E-PTFE). The filtration media is optionally pleated to provide increased surface area. Although not wishing to be bound by the following, it is postulated that moisture in the fluid stream accumulates on the outer surface of the filtration media forming a multi-layer filter having a polymer core and a water cladding layer. Removal of one or more corrosive contaminants from a fluid stream is achieved by absorbing or dissolving the gaseous corrosive contaminants of the fluid stream into the water cladding layer of the filtration media.

Polytetrafluoroethylene (PTFE) is a synthetic fluoropolymer of tetrafluoroethylene having numerous applications. The best known brand name of PTFE-based formulas is Teflon® by Chemours, a spin-off of DuPont Corporation. PTFE is a high-molecular-weight compound consisting wholly of carbon and fluorine. PTFE is hydrophobic: neither water nor water-containing substances wet PTFE, which has one of the lowest coefficients of friction of any solid. Expanded polytetrafluoroethylene (E-PTFE) is a porous form of polytetrafluoroethylene having a micro-structure characterized by nodes interconnected by fibrils. E-PTFE is produced by rapidly stretching heated PTFE, forming a microporous structure that is approximately 70% air. The production and properties of E-PTFE are described U.S. Pat. No. 3,953,566, U.S. Pat. No. 4,187,390 and U.S. Pat. No. 4,194,041. E-PTFE is commercially available from W. L. Gore and Associates, Newark, Del. E-PTFE is commercially available in the form of a pleated E-PTFE filter, sold as E-PTFE Megalam® (Camfil, Conover, N.C.).

### Contaminant Removal

Provided herein is a method of treating a contaminated fluid stream using a modified filtration media described herein. This method involves contacting the contaminated fluid stream with the modified filtration composition described below. Typically, the undesired contaminant (e.g., one or more gaseous corrosives) is removed from air, especially from air admixed with effluent gas streams resulting from municipal waste treatment facilities, paper mills, petrochemical refining plants, morgues, hospitals, anatomy laboratories, hotel facilities, museums, archives, computer and data storage rooms, semiconductor fabrication facilities, other commercial and industrial facilities, diaper boxes (e.g., used to contain used reusable diapers), vehicle exhaust, agricultural products, basement water barriers and sealants, marine environments (e.g., lacustrine, coastal and/or off-shore environments) and litter boxes, to name a few. Methods of treating gaseous or other fluid streams using different media are well known in the art. Any method known in the art of treating fluid streams with the media described herein may be used.

Gaseous contaminants to be removed and reduced from a fluid stream according to the methods described herein include, but are not limited to, water soluble corrosive gases such as hydrogen sulfide, chlorine, bromine, iodine, fluorine, sulfur dioxide, phosphorus, hydrogen bromide, hydrogen chloride, ethyl chloride, ethylene oxide, methyl bromide, methyl chloride, and/or ammonia, just to name a few.

Corrodible metals to be protected from corrosion using the methods described herein by reducing the ability of corrosive gases in the fluid stream from contacting and corroding the corrodible metals include, but are not limited to, copper, zinc, steel, aluminum, iron, silver, cobalt, manganese, chromium, palladium, cadmium, tin, indium, stainless steel, brass, any alloys thereof, any oxides thereof, any composites thereof, or any combination thereof.

Briefly, filtration media containing a water-impermeable/gas permeable polymer is placed in an air flow with the filtration media positioned in a fluid intake port of a machine such that the filter resides between the exterior of the machine and the interior of the machine and the air flow is directed from the outside of the machine through the port toward the inside of the machine and passes through the filtration media. The filtration media is optionally mounted within a housing or frame to provide a filter that maintains a two-dimensional shape of the filtration media within the confines of the entire fluid intake port, thereby reducing the ability of leakage of gaseous fluid stream at the outer boundary of the filter. Not to be bound by this theory, moisture in the fluid stream (e.g., moisture in a lacustrine environment, a coastal environment, an off-shore environment, a basement, or any combination thereof) unable to pass through the water-impermeable/gas permeable polymer of the filtration media accumulates on the outer surface of the filtration media to form an aqueous cladding layer.

Water soluble corrosive gases (e.g., a water soluble halogen, a water soluble alkali metal halide, a water soluble alkaline earth metal halide, or any combination thereof) contained in the liquid stream of air flow passing from the exterior into the interior of the machine are absorbed by the aqueous cladding layer, providing removal or reduction of corrosive materials from the air flow prior to entry of the air into the interior of the machine. Thus, the filtration media as described herein is employed for the simultaneous filtration of particulates, corrosive gases, and corrosive particulates, resulting in a reduction of corrosion of the interior of the machinery.

### Filtration Media

Generally described, the filtration media provided herein is a water-impermeable/gas permeable polymeric material such that, when exposed to water (e.g., moisture in the fluid stream being filtered), a thin layer of water forms on the surface of the filtration media. In some non-limiting examples, the filtration media is a hydrophilic material or an ultra-hydrophilic material. In some cases, the filtration media is a normally hydrophobic material that can be made hygroscopic and/or hydrophilic by any suitable means, including surface roughening, electrostatic treating, plasma treating, any suitable surface treatment, or any combination thereof. For example, the hygroscopic material is a polymer, a glass, other silicon-based materials, a composite, a metal (e.g., metal hydrides, metal oxides), or any suitable material that is naturally hygroscopic or can be made hygroscopic by synthetic routes or by surface treatment routes.

In some non-limiting examples, the filtration media is of any suitable morphology, including fibers (e.g., a fiber or a plurality of fibers), a mesh, a porous material (e.g., a zeolite), or a bed (e.g., a static bed or a fluidized bed). In some aspects, exposing the water-impermeable/gas permeable polymer filtration media of any suitable material and any suitable morphology to moisture can be a method of modifying a filter to provide a modified filter. A modified filter as described herein is any filter having a filtration media as described above wherein water can adsorb to the filtration media and form a thin film of water adhered to any exposed surface of the filtration media. Thus, a modified filter includes a multi-layer filtration media, wherein the filtration media is a core layer and the water is a cladding (i.e., sheathing) layer.

In some cases, the e-PTFE filtration media described herein is sufficiently porous (e.g., having ample surface area) to be a hygroscopic material. Thus, in some non-limiting examples, the e-PTFE filtration media is treated as described above to provide a filtration media having an e-PTFE core layer and an aqueous cladding layer. Modifying the e-PTFE filtration media to provide the multi-layer structure further provides a filtration media capable of physical and chemical filtration. For example, a fluid stream containing water soluble contaminants (e.g., corrosive gases including chlorine, bromine, fluorine, and iodine, various species thereof and/or combinations thereof, to name a few) can be filtered out of the fluid stream by contact with the modified filter as described above.

In some cases, providing and/or employing a water-impermeable/gas permeable polymer filtration media includes using an expanded PTFE (e-PTFE) polymer as described above. Briefly, an e-PTFE filter is a filter composed of a PTFE material that is modified during production to have a loose polymer network and a resulting porous surface structure. The porous surface structure allows the e-PTFE to be a hygroscopic material wherein the surface can adsorb water and provide a multi-layer e-PTFE core and water cladding layer. In some non-limiting examples, the filtration media can be any suitable hygroscopic, hydrophilic, or ultra-hydrophilic material allowing water to adsorb onto and adhere to the filtration media surface. Likewise, the filtration media contained in a filter can be produced to be hygroscopic, hydrophilic, or ultra-hydrophilic (e.g., e-PTFE), and/or treated to be hygroscopic, hydrophilic, or ultra-hydrophilic. In some cases, surface roughening, electrostatic exposure, plasma exposure, and/or coating can provide a hygroscopic, hydrophilic, or ultra-hydrophilic surface.

In some aspects, employing a filter composed of hygroscopic polymer allows creation of a filter containing a polymer having an aqueous cladding layer (e.g., a water sheath). In some non-limiting examples, exposing the hygroscopic filters to moisture (e.g., moisture in a lacustrine environment, a coastal environment, an off-shore environment, a basement, or any combination thereof) allows water to adsorb onto the surface of the hygroscopic fibers and form the aqueous cladding layer.

In some non-limiting examples, a water-clad filter as described herein can be employed to remove water soluble contaminants from an air stream. In some cases, employing the water-clad filter as described herein can simultaneously remove water soluble contaminants from an air stream and remove particulate contaminants larger than the passageway contained in the filter.

### Methods of Using

The water-clad filters and methods described herein are useful in industrial applications wherein air and/or other gaseous materials flow into or about machinery. The modified filters are provided such that any part of the machinery positioned downstream of the modified filters are more protected from corrosion than any part of the machinery positioned upstream of the modified filters. The modified filters disclosed herein are suitable for use in indoor and outdoor machinery units, including, for example, HVAC units, HVAC intakes, dehumidifiers, engine air intakes, motor housings, compressors, turbines, or any suitable application wherein gas flow being filtered for particulate contamination can also be filtered for corrosives contamination. As used herein, the meaning of “indoor” refers to a placement contained within any structure produced by humans with controlled environmental conditions. As used herein, the meaning of “outdoor” refers to a placement not fully contained within any structure produced by humans and exposed to geological and meteorological environmental conditions comprising air, solar radiation, wind, rain, sleet, snow, freezing rain, ice, hail, dust storms, humidity, aridity, smoke (e.g., tobacco smoke, house fire smoke, industrial incinerator smoke, and/or wild fire smoke, to name a few), smog, fossil fuel exhaust, bio-fuel exhaust, salts (e.g., high salt content air in regions near a body of salt water), radioactivity, electromagnetic waves, corrosive gases, corrosive liquids, galvanic metals, galvanic alloys, corrosive solids, plasma, fire, electrostatic discharge (e.g., lightning), biological materials (e.g., animal waste, saliva, excreted oils, vegetation), wind-blown particulates, barometric pressure change, and diurnal temperature change. The water-clad filters described herein provide improved corrosion protection and longer machinery life when compared to unmodified filters currently employed in a fluid stream of air being drawn into machinery.

In some instances, filtration of at least a portion of the corrosive gases found in an air flow as described herein reduce corrosion within a machine in which the water-clad filter is positioned and extend the service lifetime of the machine. For example, removing up to about 25% of the corrosive gases found in an air stream reduces corrosion and increases service lifetime of the machine up to about one year greater than when not employing a water-clad filter as described herein. In a further example, removing up to about 50% of the corrosive gases found in an air stream reduces corrosion and increases service lifetime of the machine up to about two years greater than when not employing a water-clad filter as described herein. Likewise, in a further example, removing up to about 75% of the corrosive gases found in an air stream reduces corrosion and increases service lifetime of the machine up to about four years greater than when not employing a water-clad filter as described herein.

The foregoing description of the embodiments, including illustrated embodiments, has been presented only for the purpose of illustration and description and is not intended to be exhaustive or limiting to the precise forms disclosed. Numerous modifications, adaptations, and uses thereof will be apparent to those skilled in the art.

### EXAMPLES

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative embodiments but, like the illustrative embodiments, should not be used to limit the present disclosure. The elements included in the illustrations herein may not be drawn to scale.

### Example 1

This example presents the results of an experiment to test the effectiveness of filters having water-clad filtration media composed of a pleated, expanded PTFE (e-PTFE) polymer (E-PTFE Megalam®, Camfil, Conover, N.C.) to reduce corrosion of various metal sample strips.

Metal strips individually made of copper, zinc, steel, aluminum, and stainless steel were placed into compressors deployed in a coastal environment, each having an air inlet port. A pleated, expanded PTFE (e-PTFE) polymer filter was placed in the air inlet port of each compressor. A first metal strip of each metal was placed inside the compressor downstream of the water-clad filter. A second metal strip of each metal was placed on the outer surface of the compressor upstream of the filter. The metal strips were exposed to filtered and unfiltered coastal air for one year.

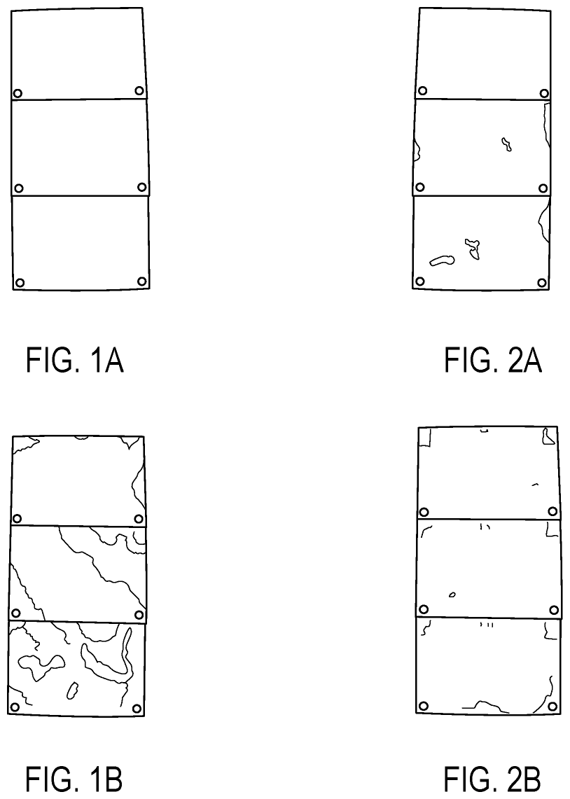

FIGS. 1A and 1B present digital images of copper metal samples exposed to a fluid stream containing sodium chloride (e.g., coastal air). FIG. 1A shows the copper metal sample exposed to an uninhibited sodium chloride-containing fluid stream, and FIG. 1B shows the copper metal sample exposed to the sodium chloride-containing fluid stream downstream of the filter. As shown in the images, the copper metal sample exposed to the uninhibited sodium chloride-containing fluid stream was corroded (see FIG. 1A) and the copper metal sample protected by the filter exhibited reduced corrosion (see FIG. 1B).

FIGS. 2A and 2B present digital images of zinc metal samples exposed to the sodium chloride-containing fluid stream. FIG. 2A shows the zinc metal sample exposed to an uninhibited sodium chloride-containing fluid stream, and FIG. 2B shows the zinc metal sample exposed to the sodium chloride-containing fluid stream downstream of the filter. As shown in the images, the zinc metal sample exposed to the uninhibited sodium chloride-containing fluid stream is corroded (see FIG. 2A) and the zinc metal sample protected by the filter exhibited reduced corrosion (see FIG. 2B).

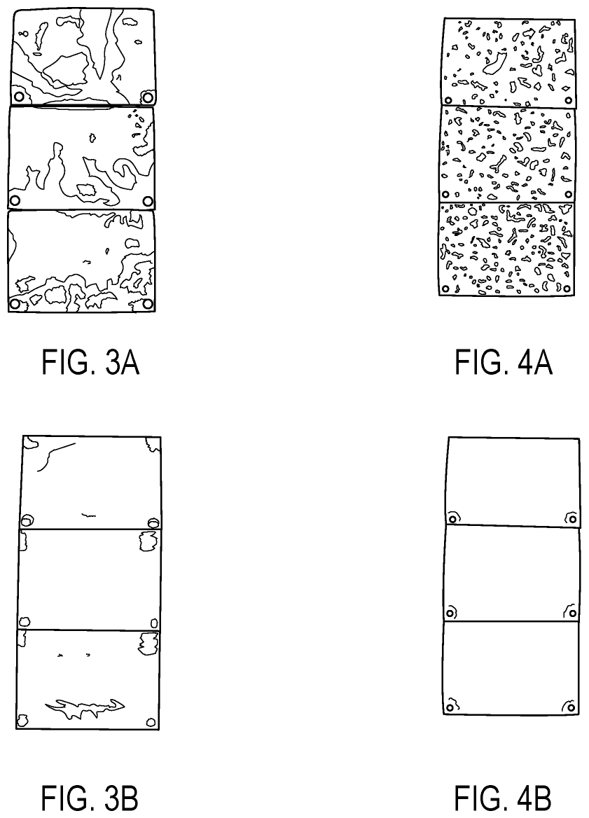

FIGS. 3A and 3B present digital images of steel samples exposed to the sodium chloride-containing fluid stream. FIG. 3A shows the steel sample exposed to the uninhibited sodium chloride-containing fluid stream, and FIG. 3B shows the steel sample exposed to the sodium chloride-containing fluid stream downstream of the filter. As shown in the images, the steel sample exposed to the uninhibited sodium chloride-containing fluid stream is corroded (see FIG. 3A) and the steel sample protected by the filter exhibited reduced corrosion (see FIG. 3B).

FIGS. 4A and 4B present digital images of aluminum samples exposed to the sodium chloride-containing fluid stream. FIG. 4A shows the aluminum sample exposed to the uninhibited sodium chloride-containing fluid stream, and FIG. 4B shows the aluminum sample exposed to the sodium chloride-containing fluid stream downstream of the filter. As shown in the images, the aluminum sample exposed to the uninhibited sodium chloride-containing fluid stream is corroded (see FIG. 4A) and the aluminum sample protected by the filter exhibited reduced corrosion (see FIG. 4B).

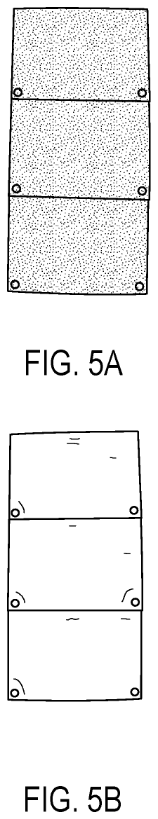

FIGS. 5A and 5B present digital images of stainless steel samples exposed to the sodium chloride-containing fluid stream. FIG. 5A shows the stainless steel sample exposed to the uninhibited sodium chloride-containing fluid stream, and FIG. 5B shows the stainless steel sample exposed to the sodium chloride-containing fluid stream downstream of the filter. As shown in the images, the stainless steel sample exposed to the uninhibited sodium chloride-containing fluid stream is corroded (see FIG. 5A) and the stainless steel sample protected by the filter exhibited reduced corrosion (see FIG. 5B).

### Example 2

This example is a potential use of the water-clad filtration media prepared as described above. In some situations, dehumidifiers are employed in environments having elevated levels of chlorine-based species. For example, a common vapor barrier for use in crawlspaces under houses is a poly(vinyl chloride) (PVC) sheet. Over time, chlorine species, including vinyl chloride, outgases from the PVC sheet and contaminates the adjacent environment. Thus, any machine (e.g., a dehumidifier) employed in such a contaminated environment can be susceptible to the deleterious effects of chlorine species (e.g., vinyl chloride) in the air. In this example, the inner machinery of the dehumidifier that is cooled by a fan blowing air from the surrounding environment into the dehumidifier to cool the inner machinery employs a particulate filter that can filter particulate contamination from the air blowing into the machine, but allow corrosive vinyl chloride gas to flow into the machinery, resulting in corrosion of the inner machinery. Replacement of the particulate filter with a pleated, expanded PTFE (e-PTFE) polymer filter (E-PTFE Megalam® (Camfil, Conover, N.C.)) having the water cladding layer reduces the flow of vinyl chloride gas into the machinery, thereby reducing corrosion of the inner machinery and extending the service lifetime of the dehumidifier.

All patents, publications and abstracts cited above are incorporated herein by reference in their entireties. Various embodiments of the invention have been described in fulfillment of the various objectives of the invention. It should be recognized that these embodiments are merely illustrative of the principles of the present invention. Numerous modifications and adaptions thereof will be readily apparent to those skilled in the art without departing from the spirit and scope of the present invention as defined in the following claims.

What is claimed is:

1. A method for reducing corrosion in machinery, comprising contacting a filtration media with a fluid stream, wherein the filtration media is positioned between the internal machinery within the machine and the fluid stream entering the machine, and wherein the filtration media adsorbs or absorbs corrosive contaminants in the fluid stream to reduce corrosion of internal machinery within the machine.

2. The method of claim 1, wherein the filtration media is positioned in a fluid stream intake port of the machine.

3. The method of claim 1, wherein the internal machinery within the machine comprises a corrodible metal.

4. The method of claim 3, wherein the corrodible metal is copper, zinc, steel, aluminum, stainless steel, or any combination thereof.

5. The method of claim 1, wherein the corrosive contaminant is a halogen gas.

6. The method of claim 1, wherein the halogen gas is chlorine, fluorine, bromine, or any combination thereof.

1. The method of claim 1, wherein the filtration media is a polymer.

8. The method of claim 1, wherein the filtration media is a water-impermeable polymer.

9. The method of claim 1, wherein the filtration media is expanded polytetrafluoroethylene.

10. The method of claim 1, wherein the filtration media is pleated, expanded polytetrafluoroethylene.

11. The method of claim 1, wherein removing the corrosive contaminants from the fluid stream comprises removing at least about 25% of the corrosives from the fluid stream.

12. The method of claim 11, wherein removing at least about 25% of the corrosive contaminants from the fluid stream comprises increasing a lifetime of the machine by at least about one year.

13. The method of claim 1, wherein removing the corrosive contaminants from the fluid stream comprises removing at least about 50% of the corrosive contaminants from the fluid stream.

14. The method of claim 13, wherein removing at least about 50% of the corrosive contaminants from the fluid stream comprises increasing a lifetime of the machine by at least about two years.

15. The method of claim 1, wherein removing the corrosive contaminants from the fluid stream comprises removing at least about 75% of the corrosive contaminants from the fluid stream.

16. The method of claim 15, wherein removing at least about 75% of the corrosive contaminants from the fluid stream comprises increasing a lifetime of the machine by at least about four years.
